(19) United States
(12) Patent Application Publication
(10) Pub. No.: US 2012/0046882 A1
(43) Pub. Date: Feb. 23, 2012

(54) METHOD OF DETECTING CONTAMINATION OF WATER USING LIVING ORGANISMS

(75) Inventors: Frank Blaker, Stavanger (NO); Eirik Sonneland, Stavanger (NO)

(73) Assignee: BIOTA GUARD AS, Stavanger (NO)

(21) Appl. No.: 13/146,831

(22) PCT Filed: Jan. 28, 2010
(86) PCT No.: PCT/GB10/00138

§ 371 Date: Nov. 10, 2011

(30) Foreign Application Priority Data
Jan. 28, 2009 (GB) 0901444.0

(51) Int. Cl. G06F 19/00

(52) U.S. Cl. 702/25

(57) ABSTRACT

Disclosed is a method of detecting contamination in an aqueous mass in the vicinity of an operation and indicating the source of the contamination, the method comprising detecting signals which may be indicative of aqueous contamination using a plurality of sentinel species containing sensor units disposed in the aqueous mass in the vicinity, relaying data relating to the signals to an analyser, analysing data received by the analyser, and relaying an analysis result indicative of the existence, severity and source of the contamination to an operator, wherein the method also comprises relaying further data to the analyser selected from data in the group consisting of data relating to the performance of the operation, data relating to environmental releases in the vicinity by parties other than the operator, data relating to the topography of the vicinity, and third party data relating to the properties of the aqueous mass in the vicinity.

The present invention relates to improvements in and relating to a method of monitoring an aquatic mass, e.g. a zone of a river, lake, sea or ocean, for example a harbour or the water surrounding an offshore hydrocarbon well, in order to detect contamination, and additionally to apparatus for use in such a method.

In operations carried out off-land, e.g. offshore drilling and water-to-land or land-to water material transfers at harbours, there is a risk of spillage or other releases into the aquatic mass of contaminants that may adversely affect the local aquatic species. Such spillages or releases are not only environmentally undesirable but may cause the operator responsible to be exposed to fines or to have to halt operation. It is therefore of great interest to operators who might be accused of causing such events to learn as rapidly as possible of the occurrence of any event and its severity and whether they are indeed responsible.

Thus, for example, in offshore drilling and hydrocarbon recovery there are risks that materials released into the water surrounding the wellhead or the drilling and/or production platform may reach levels at which marine life in the vicinity is endangered. Discharges may be operational or accidental. Examples of operational discharges include produced water during the production stage and drilling fluids and cuttings during the drilling stage. Examples of accidental discharges include hydrocarbons, hydraulic fluids, drilling fluids, cuttings and other chemicals. It is important that such discharges do not cause unacceptable water contamination or other environmental effects and so, when unacceptable discharges occur, it is important for the well operator to take action to reduce or stop contaminant release.

Such actions may include shutting down drilling operations, stopping hydrocarbon recovery, replacing or repairing equipment, and so on, all of which are expensive. It is therefore important for the well operator to be able to determine not only that contamination has occurred but also the source, nature and severity of the contamination: thus for example if contamination is as a result of leakage from passing shipping, corrective action by the well operator would be ineffective, and if contamination is below threshold values for severity then corrective action may as yet not be required.

Monitoring of contamination of water masses is well-known and in earlier patent applications (WO2007/086754 and WO2009/013503, the contents whereof are hereby incorporated by reference) we have described how sentinel species, e.g. fish or shellfish, particularly bivalves, may be used to determine whether an operator is responsible for such contamination. Nonetheless, further improvement in this field remains desirable.

We have now found that incorporation of operator-supplied data relating to the operator's operation and of third party data relating to weather and other operator's activities may increase the efficacy of the method. Moreover, the incorporation of such further data into the result presented to the operator by the operation of the method of the invention simplifies the operator's decision as to whether or not to take action by avoiding the need for the operator to integrate the monitoring result with other information he may receive or have to hand, and as a result corrective action may be taken more promptly and environmental damage and any penalties therefor may be reduced.

Viewed from one aspect therefore the invention provides a method of detecting contamination in an aqueous mass in the vicinity of an operation and indicating the source of said contamination, said method comprising detecting signals which may be indicative of aqueous contamination using a plurality of biosensor-containing sensor units disposed in the aqueous mass in the vicinity of said operation, relaying data relating to said signals to an analyser, analysing data received by said analyser, and relaying an analysis result indicative of the existence, severity and source of said contamination to the operator of said operation, characterised in that the method also comprises relaying further data to said analyser selected from data in the group consisting of data relating to the performance of said operation, data relating to environmental releases in said vicinity by parties other than the operator, data relating to the topography of said vicinity, and third party data relating to the properties of the aqueous mass in said vicinity.

In the method of the invention, so as to increase the ecological relevance and topicality of the analysis result, it is preferred that data relating to at least two and preferably at least three parameters which are monitored continuously or at intervals of no more than 48 hours, are utilized in the data analysis.

While the operator in the method of the invention will most generally be the operator of an offshore hydrocarbon well or drilling rig, the operator may also be the operator of a water-going vessel or of a harbour or other facility for land/water material transfer. Land to water material transfer monitored according to the invention may relate not only to vessel loading but also to intentional or unintentional discharges from land-based industrial operations, such as factories, refineries (e.g. oil and metal refineries), and mines. Water to land material transfers may likewise include not just vessel unloading but also salt water intake to desalination plants.

By third party, is meant a party other than the operator, e.g. an individual or a corporate body.

The sensor units will generally be disposed about the operation, particularly both upstream and downstream in the sense of the normal water-flow direction(s), if any. Obviously, where the operation is at the water's edge, by about we mean still within the water. As discussed further below, sensor units may be disposed both near-surface and near water-bed and also both close to and distant from the operation. In general, at least three, preferably at least five, and more preferably at least ten, sensor units will be deployed.

The analyser used in the method of the invention will generally be a computer which, although preferably off-site may be deployed at the site of the operation. Off-site deployment facilitates upgrading by the performer of the method who may not be the operator of the operation. Thus, viewed from an alternative aspect the invention provides a method of detecting contamination in an aqueous mass in the vicinity of an operation and indicating the source of said contamination, said method comprising analysing data including data relating to signals which may be indicative of aqueous contamination detected using a plurality of biosensor-containing sensor units disposed in the aqueous mass in the vicinity of said operation, and thereby generating an analysis result indicative of the existence, severity and source of said contamination to the operator of said operation, characterised in that the data analysed further comprises data selected from data in the group consisting of data relating to the performance of said operation, data relating to environmental releases in said vicinity by parties other than the operator, data relating to the topography of said vicinity, and third party data relating to the properties of the aqueous mass in said vicinity.

By a result, is meant a quantitative, semi-quantitative or qualitative signal, e.g. indicating that all is well or that action is required or indicating that a contaminant has reached a particular level. This may be relayed continuously or, less preferably, regularly, particularly at intervals of up to 48 hours but preferably no less than daily. By indicative of source, the relayed result may simply indicated if detected contamination is deemed to come from the operation. Where the contamination is deemed by the analysis to derive from elsewhere than the operation, the relayed result may be an all-clear signal, although the fuller result identifying the likely source should desirably be recorded.

Viewed from a further aspect the invention provides a computer programmed to receive the data referred to and to generate a result as described. From a still further aspect the invention provides a data carrier, e.g. a disc, tape or memory device, carrying a computer program capable of use to program a computer to receive the data referred to and to generate a result as described. Viewed from another aspect, the invention provides a such computer program. Conventional computers and data carriers may be used in this regard and the program may incorporate standard modelling modules such as are known in the petrochemical industry.

By way of example, operator-supplied further data may relate to the presence of man-made structures other than vessels in the vicinity, the water-bed topography, visual images of the vicinity of the operation, detected seismic activity in the vicinity, the timing, extent and nature of the actions in the operation, whether intended or not, e.g. the release of produced water, leakages of drilling fluids or other chemicals, the performance of drilling, etc. Similarly, third party supplied further data may relate for example to the water-bed topography in the vicinity, detected seismic activity in the vicinity, the presence of other man-made structures, other than vessels, in the vicinity, water flows and temperature in the vicinity, contamination levels and types detected in the aqueous mass, baseline contamination levels and types, sentinel species' responses to contaminants and disturbances, satellite photographs, and activities, e.g. loading and unloading or releases of other parties operating in the vicinity.

One example of the way the inclusion of such further data increases the efficacy of the method of detecting and identifying the cause of contamination is that the signals detected from the biosensor, e.g. pulse rate or shell movement, can be responsive to causes other than contamination. Thus, in quiet areas, a sudden increase in noise or vibration, caused for example by a passing vessel or activity on a rig, can generate a signal unrelated to a contamination event.

In a preferred embodiment, the method of the invention is a method of detecting seawater contamination from an offshore hydrocarbon well facility comprising a plurality of seabed wellheads connected by hydrocarbon conduits to a seabed pipeline head (e.g. a PLEM) from which a hydrocarbon pipeline leads to a remote hydrocarbon receiving facility, each said wellhead being provided with a protective cover (eg an over-trawlable wellhead protection structure—WHPS) to which is removably attached a sensor unit, each said sensor unit comprising a biological sensor and a data transmitter coupled by a data transmission line to said remote facility, said well facility further comprising a seawater velocity sensor, a seawater conductivity sensor and a temperature sensor also coupled by a data transmission line to said remote facility, wherein data is analysed to determine indicia of seawater contamination at said well facility and of the seawater flow at said well facility and thereby to provide a signal indicative of seawater contamination above a preselected limit deriving from said well facility.

In another preferred embodiment the method uses apparatus for detecting seawater contamination from an offshore hydrocarbon well facility, said apparatus comprising a plurality of removably attached sensor units each attached at the protective cover of a wellhead of said offshore hydrocarbon well facility and each comprising a biological sensor and a data transmitter coupled by a data transmission line to a remote data analysis facility (eg part of a hydrocarbon receiving facility coupled via a hydrocarbon pipeline to a seabed pipeline head (eg a PLEM) at said offshore hydrocarbon well facility), said apparatus further comprising at said offshore hydrocarbon well facility a seawater velocity sensor, a seawater conductivity sensor and a temperature sensor also coupled by a data transmission line to said remote facility, said apparatus optionally and preferably further comprising a computer arranged to analyse data to determine indicia of seawater contamination at said well facility and of the seawater flow at said well facility and thereby to provide a signal indicative of seawater contamination above a preselected limit deriving from said well facility.

It is particularly preferred that such well facilities also comprise a submerged sediment trap.

In a preferred embodiment of the invention, each sensor unit comprises a said seawater velocity sensor, a seawater conductivity sensor and a temperature sensor also coupled by a data transmission line to said remote facility.

In an especially preferred embodiment a further such sensor unit is removably attached at the seabed pipeline head module (i.e. the PLEM).

In a particularly preferred embodiment of the invention, at least one further sensor unit is placed at a seabed location remote from the well facility, e.g. at a distance of 500 to 1000 m from any wellhead, PLEM or pipeline, especially at a distance of 800 to 2000 m. Such “outlier” sensor units may serve to determine a “background” or “control” value for contamination and are desirably placed around the well facility (where at least three outliers are present) or upstream of the well facility in the sense of the normally prevailing seabed current. Data transmission from outliers may be via a data transmission line or more preferably by acoustic transmission from a transmitter at the outlier through the seawater to a receiver coupled to the main data transmission line leading from the PLEM, optionally via an intermediately positioned seabed transceiver. Acoustic transmissions in the method of the invention are preferably non-continuous, e.g. occurring at time intervals of at least 1 hour and up to 24 hours, and preferably are at frequencies in a wavelength band which has little or no effect on whales, in particular frequencies outside the 17 to 43 kHz band, particularly outside the 1 to 100 kHz band.

The sentinel species containing biosensors in the sensor units are preferably raised relative to the seabed to reduce the influence of normal dirt-raising seabed currents, e.g. at a minimum height of 1 to 10 m, especially 2 to 5 m above the surrounding seabed. The bottom of the biosensor for these purposes maybe considered to be the lowest portion of the biosensor in which the species being monitored (the “sentinel” species) is contained.

The well facility sensor units may optionally and preferably also include sensors selected from the following:

acoustic sensors (e.g. hydrophones);

mass spectrometers;

NMR spectrometers;

Heart rhythm sensors;

pH sensors;

seawater pressure sensors;

turbidity sensors;

dissolved oxygen sensors;

passive sampling devices;

chlorophyll sensors; and

sediment traps;

in particular one or more of the latter five such sensors.

Passive sampling sensors may be used to detect organic compound contaminants, e.g. aromatic compounds, and generally operate by the use of a semi-permeable membrane which separates the seawater from a solvent in which the organic compounds are soluble. The solvent may be recovered and analysed when the sensors are periodically replaced or, more preferably, a spectrometric device is included which can analyse the solvent for organic compound content in situ, e.g. an infra-red spectrophotometer.

The chlorophyll sensor may be a spectrofluorometer and serves to detect changes in the flora of the body of water surrounding the sensor, e.g. changes in algal content.

The biosensor may be one or more of the many known biosensors which operate by detecting the effect of changes in the seawater on a selected living species, the sentinel species, usually fish or macroinvertebrates (eg shellfish, crustaceans, sea urchins (eg echinodermata), molluscs, sponges, and fish, especially filter feeding species, and in particular mussels, clams and scallops), for example changes in respiration, pulse (or heart rhythm), gill movement, population density, growth rate, siphon operation, shell movement (e.g. closure and opening, and valve gap and motion), etc. For this purpose, the biosensors will generally include optical recording apparatus, e.g. a camera, and optionally also light sources, e.g. lasers. Such effects are known to be correlatable to changes in chemical and physical environment.

The sentinel species is preferably one suited to the normal (i.e. non-contaminated) environment at the location at which the biosensor is to be deployed, taking into account parameters including depth, temperature, salinity, biomass content of the surrounding water, etc, and one which is responsive to the types of contamination possible in the event of malfunction of the well facility. Typical examples include macroinvertebrate filterfeeders such as mussels, clams, scallops and oysters. The use of such sentinel species in biomonitoring is discussed for example in U.S. Pat. No. 6,119,630 (Lobsiger), U.S. Pat. No. 6,058,763 (Shedd), U.S. Pat. No. 5,798,222 (Goix), and FR-A-2713778 (Pennec) and by Al-Arabi et al in Environmental Toxicology and Chemistry 24:1968-1978 (2005) and Gruber et al in Water, Air and Soil Pollution 15:421-481 (1981), the contents of all of which are incorporated herein by reference.

In the performance of the present invention the use of bivalves, and in particular mussels, clams and scallops, is preferred.

The sentinel species is housed within the biosensor in such a way that it contacts the seawater at the sensor location but is retained within the sensor, e.g. by the use of a cage with a perforated or mesh wall.

Monitoring will typically be to detect movement of the sentinel species within the sensor (e.g. opening or closing of bivalve shells), or localized variations of movement of water within the sensor, or localized changes in water turbidity, or light or sound emissions or reflections by the sentinel species.

All such measurements may be calibrated against equivalent measurements for the same sentinel species under a range of physico-chemical conditions (e.g. temperature, pressure, salinity, microbe content, sediment content, light intensity, etc.) at a series of different pollutant contents and pollutant exposure periods. In this way, the signals from the biosensors may be analysed to determine whether the presence of particular pollutants is likely and whether it is at unacceptably high levels. Setting up a calibration is facilitated by multivariate or principal component analysis which may be used to produce a prediction matrix which can be applied to the data provided by the sensor units.

Certain of the monitored parameters of the sentinel species, e.g. growth, valve gap, heart rate, etc, can be used in existing environmental models such as DREAM (dose-related environmental risk assessment) which are already in use by the oil and gas industry. Data input from the methods of the invention may thus be used to enhance the reliability and accuracy of the results from such models.

While continuous real-time monitoring is possible according to the invention, it will not always be necessary and data sampling may be effected instead at intervals, e.g. of 1 to 48 hours, optionally with data being collected and averaged between sampling times. Desirably however, the sensor units will be arranged to override any temporally spaced sampling should the detected values of the parameters under study fall outside a “normal operating window”, i.e. so that leakages may be detected and dealt with promptly.

The data from the sensor units may thus be used to calculate an indication of contamination from the biosensors, and to determine whether the cause is external to the well facility (e.g. by comparison with outliers and comparison between the biosensors taking into account the seawater velocity (i.e. speed and direction in the horizontal plane) and by correction for influence of temperature, pressure, salinity (itself determinable from the detected conductivity), transient biomass (determinable from the detected chlorophyll concentration), and transient turbidity (e.g. due to unduly high seabed turbulence)).

Where external factors cannot be ruled out, data from the passive sampling sensors may be used to increase the degree of confidence in the contamination indication, and if necessary the biosensors may be retrieved, e.g. using submarines such as AUVs and ROVs, so that autopsies, biopsies or other analyses may be performed. Together this can give rapid confirmation that contamination above a preset threshold has occurred or is occurring and as to whether this is attributable to the operation of the well facility. This enables the well operator to take corrective action with a minimum of delay, e.g. by stopping or slowing hydrocarbon production at one or more of the wellheads, by repairing the wellhead equipment responsible for leakage, etc.

In an alternative form, the invention is also suitable for monitoring the operation of an offshore hydrocarbon well facility which includes a surface (i.e. sea-surface) platform, e.g. a floating or static drilling and/or production platform. In this instance however, two arrays of sensor units are required, one at the seabed and one submerged but near the sea surface.

In this embodiment, the method of the invention may be a method of detecting seawater contamination from an offshore hydrocarbon well facility comprising a sea surface drilling or production platform (or a combination of such platforms) connected to a seabed wellhead, wherein a first plurality of at least three submerged sensor units is arranged around said platform at a depth of 15 to 50 m and at a distance of 50 to 500 m and a second plurality of at least three sensor units is arranged at the seabed around said wellhead at a distance of 50 to 500 m, each said sensor unit comprising a biological sensor and a data transmitter, said well facility further comprising a submerged sediment trap, a seawater velocity sensor, a seawater conductivity sensor, a seawater temperature sensor, and a data receiver arranged to receive data from said transmitters, in which method data analysed to determine indicia of seawater contamination at said well facility and of the seawater flow at said well facility and thereby to provide a signal indicative of seawater contamination above a preselected limit deriving from said well facility.

In this embodiment the invention may use apparatus for detecting seawater contamination from an offshore hydrocarbon well facility comprising a sea surface drilling or production platform (or a combination of such platforms) connected to a seabed wellhead, said apparatus comprising a first plurality (ie an array) of at least three submerged sensor units arranged around said platform at a depth of 15 to 50 m and at a distance of 50 to 500 m and a second plurality of at least three sensor units arranged at the seabed around said wellhead at a distance of 50 to 500 m, each said sensor unit comprising a biological sensor and a data transmitter, said apparatus further comprising a submerged sediment trap, a seawater velocity sensor, a seawater conductivity sensor, a seawater temperature sensor, and a data receiver arranged to receive data from said transmitters, said apparatus optionally and preferably further comprising a computer arranged to analyse data to determine indicia of seawater contamination at said well facility and of the seawater flow at said well facility and thereby to provide a signal indicative of seawater contamination above a preselected limit deriving from said well facility.

The sensor units of the first array are preferably buoyant, or attached to a buoy, and connected to a seabed anchoring device, e.g. by a flexible cable, such that in all predictable weather and sea flow conditions they remain at least 50 m from the closest part of the platform or its connection to the seabed, and such that except in extreme weather or sea flow conditions they remain no more than 600 m from such closest parts. The units are submerged, that is to say no part, including any other connected parts, is at or above the sea surface except in storm conditions, e.g. a storm force of 8 or above on the Beaufort scale. Typically anchoring will be such that under calm conditions all parts are at least 15 m below the sea surface and the base of the biosensor is no more than 50 m below sea surface.

The sensor units of the second array are preferably located such that the biosensors are at a height of 1 to 10 m, especially 2 to 5 m, above the surrounding seabed. They may be fixed, e.g. mounted on rigid supports, or alternatively they too may be buoyed or buoyant and tethered to a seated anchoring device. These sensor units are preferably located between 50 and 500 m from the nearest platform support, wellhead or seabed pipeline. Further seabed sensor units, “inliers”, may if desired be placed between wellheads or within the area defined by three or more wellheads.

The two arrays preferably each comprise at least 4, especially at least 6, e.g. up to 30, sensor units spaced apart by no more than 100° from a central vertical axis, e.g. an axis through the platform, wellhead or wellhead cluster. The sensor spacing may be uneven, e.g. with sensor units being more densely clustered downstream than upstream (with regard to the dominating current direction)of the platform or, respectively, the wellhead(s).

Besides the first and second sensor unit arrays and any inlier sensor units, outlying submerged but near surface sensor units and outlying seabed sensor units, e.g. at a distance of 500 to 10000 m, especially 800 to 2000 m, are also preferably present, again to provide background or control values for contamination. These again may be around the platform or wellhead(s) or upstream as discussed earlier.

Still further sensor units, “platform sensor units”, may if desired be placed on the seabed-to-platform supports of a fixed platform. In this case such platform sensor units may contain physical and/or chemical sensors only, e.g. seawater velocity sensors. Again velocity in this instance may be approximated by horizontal flow rates and velocities.

Where seabed sensor units can be attached to or located within existing subsea structures, this will generally be preferred as such sensors need not then be provided with trawl protection structures.

It is preferred that the submerged but near surface sensor units comprise seawater velocity, seawater conductivity and temperature sensors and optionally but preferably one or both of pressure and chlorophyll sensors. Further sensors of the types already described may also be included.

It is preferred that the seabed sensor units comprise sensors of the types already described for the well facilities having no surface platforms, especially sediment traps.

Data transmission from the sensor units of the first array and the near-surface outliers may be via a data transmission line, e.g. an electric cable or optical fiber, for example running down the tethers to the seabed. In a preferred embodiment, however, data transmission from such sensor units is by acoustic transmission as discussed above, optionally via intermediate transceivers (again subsurface and for example on buoys tethered to the seabed). The use of acoustic data transmission in this way transforms the sensor unit/tether array from being a potential obstacle for anchor handling and other maintenance activity around the platform or sub-sea installation into a useful grid location system, eg for vehicles such as ROVs and AUVs used in these activities.

Data transmission from the second array of sensor units and the seabed inliers and outliers may again be via a data transmission line or may be by acoustic transmission as described earlier.

Data transmission from platform-mounted sensor units is preferably by acoustic signal or via a data transmission line to the platform.

It will generally be preferable, wherever possible, to use (e.g. piggy-back upon) communication infrastructure that is already in place for data transmission from the sensor units, especially the seabed units, for example optical fibres or power transmission lines.

Transmitted data is preferably collected at the platform for analysis there or for transmission, e.g. by radio, to a remote computer, e.g. at an onshore facility.

The sensor units are preferably wholly or partially dismountable, e.g. using ROVs or AUVs, for replacement of sensors, e.g. for analysis at remote locations as discussed above.

Data analysis and signal/indicia generation may be effected analogously to data analysis for the surface-platform-free well facilities discussed above.

The sensor units, as mentioned above, may include acoustic sensors such as hydrophones. Such acoustic sensors are particularly useful in detecting leakages from subsea frames or installations.

It will be appreciated that, besides the sensor units required for the methods of the invention to incorporate biosensors, the overall set of sensor units used in the methods may include sensor units which do not contain biosensors, for example because they are located at depths at which it is difficult to maintain the sentinel species alive.

Advantageously, the contamination levels before, or at the onset of monitoring using the methods of the invention may be measured and used as a baseline so that monitoring alerts the operators to variations relative to the baseline values or so as to more readily highlight contamination events occurring during monitoring. Likewise, if monitoring according to the invention is for a limited period only, e.g. during a high risk operation, determination of contamination levels before and after the monitoring period may more effectively pinpoint contamination events occurring during monitoring. Such contamination determination may of course be effected with sentinel species and/or by chemical analysis in situ or at a remote location (e.g. a laboratory) and/or by determination of biological effect at such a remote location.

In the methods of the invention, it is particularly desirable that at least on “reference” biosensor be placed in the aquatic mass at a location that is unlikely to be affected by the operation or by third party activities or natural events, e.g. away from the water flow from and to the operation, from third party operations, and shipping routes. Such reference biosensors may provide baseline data for the data analysis.

Desirably the data collected by the methods of the invention are correlated to the same time-line so as to improve the cause/effect analysis.

By well facility, it should be noted, is meant herein a facility having a hydrocarbon well in preparation, in operation, or in shutdown mode.

In an especially preferred embodiment, the data set for analysis according to the invention includes weather data and vessel movement data collected at the offshore installation using conventional weather monitoring devices (for example for wind speed, air temperature, air pressure, humidity, visibility, light intensity, etc) or vessel detection apparatus, e.g. radar. In this way, causes of variation in the sensor signals which are extraneous to the operation of the offshore installation may more easily be identified and the frequency of “false positive” alerts reduced.

In a further preferred embodiment of the method of the invention, the operation is a harbour. In this case, sensor units will preferably be deployed on the water-bed within the harbour: however, the data from such units will generally serve to alert the operator to the occurrence of a contamination event rather than its source, as it may not be possible to discriminate between vessels within the harbour. Sensor units likewise will preferably be deployed near-surface at the sides of the entry channel and on the water bed within that channel: data from such sensors will assist in determining the cause of any contamination event. Such sensors will preferably be positioned relative to the surface or water bed as described earlier. Further sensors will preferably be deployed near surface and/or near water bed at 500-1000 m (inliers) and at 2000-5000 m (outliers) from the harbour entrance. Preferably the inlier sensor array is both at surface and bed; the outlier array is preferably at least at surface. The harbour entrance may conveniently be defined as the line directly joining surface or surface connected structures (e.g. piers) of the harbour.

In a yet further embodiment, the operation may be a land/shore material transfer terminal which is not within a harbour. In this case, sensor units will preferably be deployed near surface and/or near water bed at 500-1000 m (inliers) and at 2000-5000 m (outliers) from the operation. Preferably the inlier sensor array is both at surface and bed; the outlier array is preferably at least at surface.

In a still further embodiment, the operation may be a desalination plant, the water for which is drawn from the aquatic mass. In this embodiment, the biosensors are preferably arranged about the inlet with a plurality of inliers preferably being located within 1000 m, more preferably within 500 m, e.g. 200-100 m, of the inlet. An outlier array of biosensors, e.g. within 2000-5000 m of the inlet may be desirable; however, preferably at least one reference biosensor will be used.

In another embodiment, the operation is a land-based industrial operation (e.g. a factory, refinery, or mine) from which there may be intentional or unintentional discharges into the aquatic mass, e.g. through pipelines leading into the aquatic mass or by virtue of surface water run-off. In this embodiment, a plurality of inlier biosensors will preferably be arranged in the aquatic mass about and in close proximity to the possible contamination sites, e.g. a pipeline or a water run-off point, for example within 100 m and preferably both near surface and near water-bed as discussed earlier. Advantageously, there will also be a plurality of outlier biosensors, e.g. at 1000-5000 m from the possible contamination site and also a reference biosensor.

For both desalination plants and land-based industrial operations, the inlier biosensors are preferably placed at intervals of no more than 100 m, particularly no more than 50 m, especially no more than 25 m. Where their spacing is small, near surface and near water-bed biosensors may alternate.

For all embodiments, in certain circumstances, it may be desirable to place inlier biosensors much closer to the possible contamination site, e.g. within 50 m.

Likewise, for all embodiments, it may be sufficient to have only two biosensors, a reference biosensor as discussed above and an inlier placed very close, e.g. within 20 m, to the possible contamination point.

Preferred embodiments of the present invention will now be described by reference to the accompanying drawings, in which:

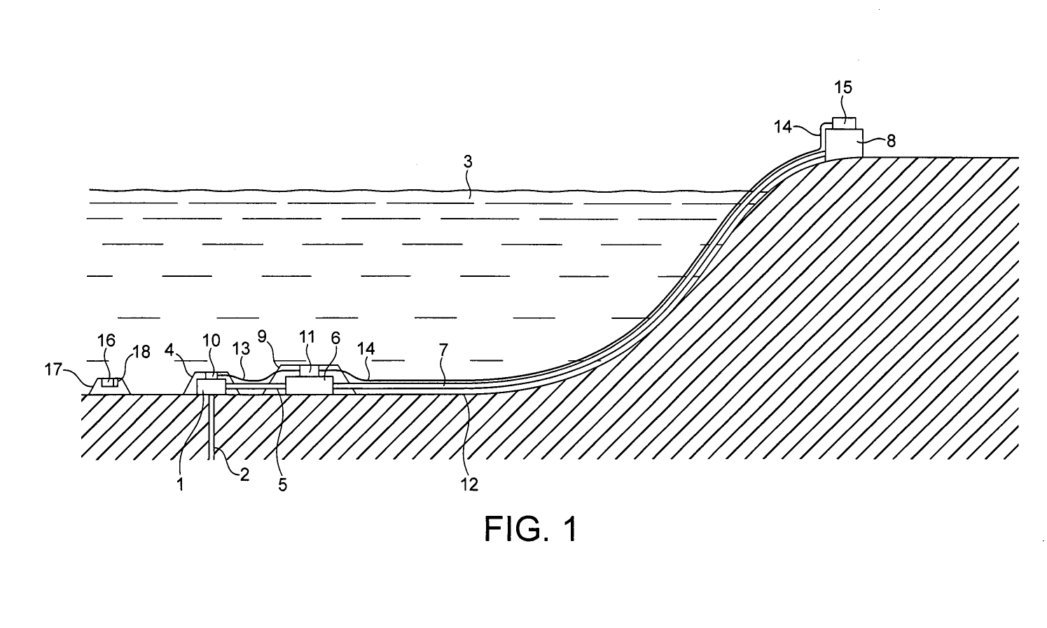

FIG. 1 is a schematic horizontal view of a first well facility having apparatus according to the invention;

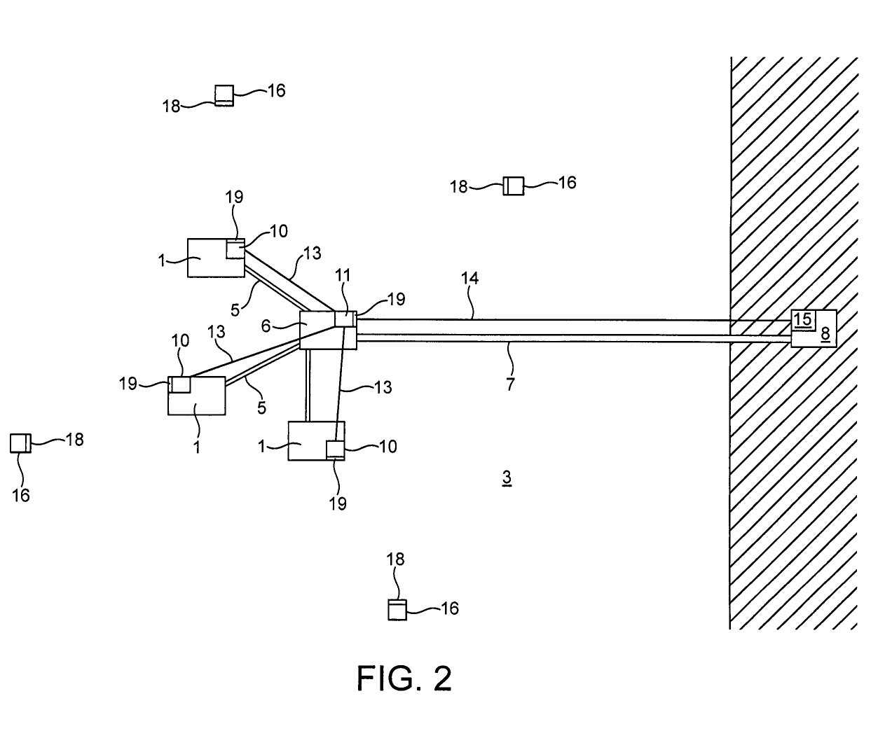

FIG. 2 is a schematic view from above of a well facility as in FIG. 1;

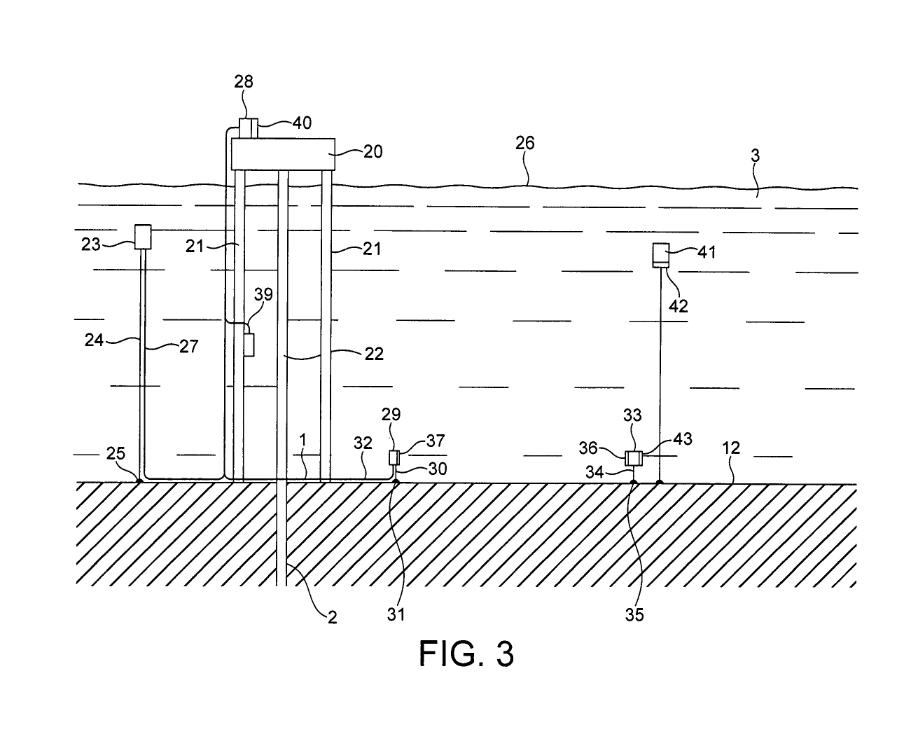

FIG. 3 is a schematic horizontal view of a second well facility having apparatus according to the invention;

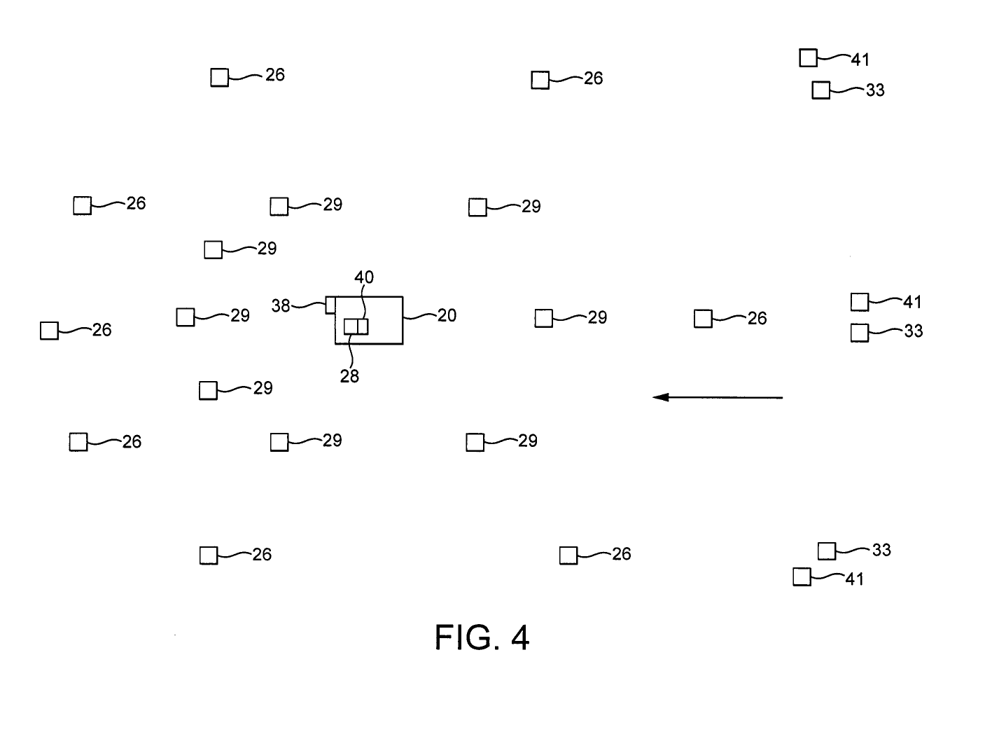

FIG. 4 is a schematic view from above of a well facility as in FIG. 3; and

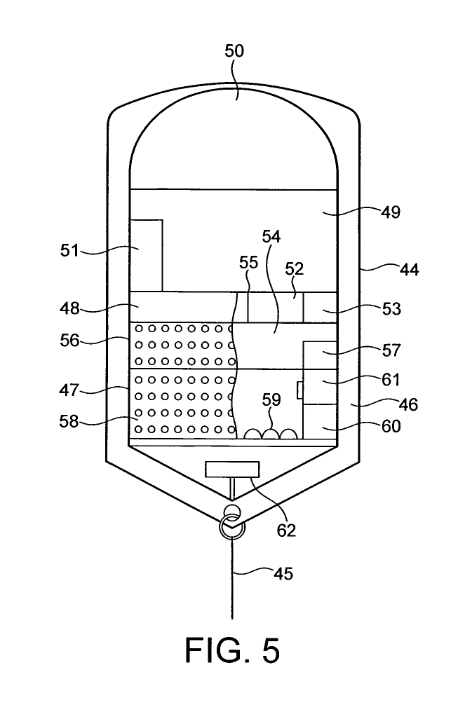

FIG. 5 is a schematic side-on view of a sensor unit usable according to the invention.

Referring to FIG. 1 there is shown a wellhead 1 of a hydrocarbon well 2 under seawater 3. Wellhead 1 is provided with a protective cage 4 (an over-trawlable WHPS) to prevent damage by trawling nets and feeds hydrocarbon into minor pipeline 5. Hydrocarbon minor pipeline 5 and similar lines from several other wellheads (not shown) feed hydrocarbon to a pipeline end module (PLEM) 6 which combines the flow and feeds it into major pipeline 7 which leads to a remote onshore receiving facility 8. PLEM 6 is also provided with a protective cage 9 and sensor units 10 and 11 are respectively mounted within cages 4 and 9 at a minimum height of 2 m above the seabed 12. Data transmission lines 13 and 14 lead from the wellhead and PLEM to a data analyser unit 15 at the onshore facility which also receives further data from third party suppliers and the wellhead operator.

At a distance of 300 m from wellhead 1 is a further sensor unit 16 similarly mounted within a protective cage 17 and provided with an acoustic data transmitter 18 for transmission of data to an acoustic receiver 19 on sensor unit 10.

Referring to FIG. 2, there is shown an array of sensor units 10 on a set of wellheads 1 around PLEM 6 and a further array of outlier sensor units 16. In this figure, cages 4, 9 and 17 are not shown.

Referring to FIG. 3 there is shown a static drilling and/or production platform 20 having legs 21 to seabed 12. Drill string 22 leads via wellhead 1 to hydrocarbon well 2.

A buoyant submerged sensor unit 23 is tethered by cable 24 to seabed anchor 25 such that it is 30 m below the sea surface 24 and 100 m from legs 21. Data transmission line 27 leads from sensor unit 23 down cable 24, across seabed 12, and up leg 21 to a data collection unit 28.

A seabed sensor unit 29 is tethered by cable 30 to seabed anchor 31 such that it is 2 m above the seabed and 60 m from legs 21. Data transmission line 32 leads from sensor unit 29 down cable 30, across seabed 12 to join with data transmission line 27.

An outlier seabed sensor unit 33 is tethered by cable 34 to seabed anchor 35 such that it is 2 m above the seabed and 800 m from legs 21. Sensor unit 33 is provided with an acoustic transmitter 36 to transmit data to acoustic receiver 37 on sensor unit 29.

A further sensor unit 38 is attached to leg 21 and is provided with a data transmission line 39 which joins data transmission line 27.

A near-surface buoyant outlier sensor unit 41 is tethered as for sensor unit 23 but 800 m from leg 21. This sensor unit is provided with acoustic transmitter 42 which transmits data to acoustic receiver 43 on seabed outlier sensor unit 38.

Data collected by collection unit 28 is transmitted by radio transmitter 40 to a remote data analyser (not shown).

Referring to FIG. 4, there is shown from above the drilling and/or production platform 20, the first array of submerged near-surface sensor units 26, the second array of seabed sensor units 29, outlier submerged near-surface sensor units 41, and outlier seabed sensor units 33. The arrow indicates the “normal” seawater current direction.

Referring to FIG. 5, there is shown a sensor unit 44 attached to the seabed via cable 45 and comprising a frame 46 carrying four compartments 47, 48, 49 and 50. Compartment 50 is a sealed gas-containing buoyancy tank. Compartment 49 is a sealed unit containing a data receiver (not shown) and carrying on its exterior an acoustic data transmitter 51. Compartment 48 (shown partly cut away) is a detachable two compartment tank in which upper sealed compartment 52 is filled with an organic solvent, contains an infra-red spectrophotometer 53, and is separated from lower compartment 54 by a semi-permeable membrane 55 through which organic compounds may pass. Lower compartment 54 has a perforated peripheral wall 56 and contains a temperature sensor 57.

Compartment 47 (also shown partly cut away) is also detachable and has a perforated peripheral wall 58 and contains mussels 59 as the monitored biological species. The mussels are illuminated by light source 60 and monitored by camera 61.

The compartments may alternatively be arranged so that samples of the sentinel species or samples from passive sampling devices may be removed while the compartments remain in situ.

Below compartment 47 is mounted a flow meter 62 which is freely rotatable about a vertical axis and which is provided with a solid state compass (not shown) so that flow direction is also measured.

1. A method of detecting contamination in an aqueous mass in a vicinity of an operation and indicating a source of said contamination, said method comprising:
detecting signals which may be indicative of aqueous contamination using a plurality of sentinel species containing sensor units disposed in the aqueous mass in the vicinity of said operation;
relaying data relating to said signals to an analyser;
analysing data received by said analyser; and
relaying an analysis result indicative of the existence, severity and source of said contamination to the operator of said operation;
wherein the method further comprises:
relaying further data to said analyser selected from data in the group consisting of data relating to the performance of said operation, data relating to environmental releases in said vicinity by parties other than the operator, data relating to a topography of said vicinity, and third party data relating to the properties of the aqueous mass in said vicinity.

2. A method of detecting contamination in an aqueous mass in a vicinity of an operation and indicating a source of said contamination, said method comprising:
analysing data comprising data relating to signals which may be indicative of aqueous contamination detected using a plurality of sentinel species containing sensor units disposed in the aqueous mass in the vicinity of said operation, and thereby generating an analysis result indicative of the existence, severity and source of said contamination to the operator of said operation;
wherein the data analysed further comprises data selected from data in the group consisting of data relating to the performance of said operation, data relating to environmental releases in said vicinity by parties other than the operator, data relating to a topography of said vicinity, and third party data relating to the properties of the aqueous mass in said vicinity.

3. The method as claimed in claim 1 wherein said operation is a desalination plant.

4. A method as claimed in claim 1 wherein said operation is a harbour.

5. A method as claimed in claim 1 wherein said operation is a land-based factory, refinery or mine.

6. A method as claimed in claim 1 wherein said operation is an offshore hydrocarbon well.

7. A method as claimed in claim 1 wherein said operation is a land to shore or shore to land material transfer terminal located outside a harbour.

8. A method as claimed in claim 2 wherein said operation is a desalination plant.

9. A method as claimed in claim 2 wherein said operation is a harbour.

10. A method as claimed in claim 2 wherein said operation is a land-based factory, refinery or mine.

11. A method as claimed in claim 2 wherein said operation is an offshore hydrocarbon well.

12. A method as claimed in claim 2 wherein said operation is a land to shore or shore to land material transfer terminal located outside a harbour.
